(19) United States
(12) Patent Application Publication
(10) Pub. No.: US 2021/0294884 A1
(43) Pub. Date: Sep. 23, 2021

(54) AUTHENTICATION SYSTEMS AND METHODS USING A BRAIN COMPUTER INTERFACE

(71) Applicant: HI LLC, Los Angeles, CA (US)

(72) Inventors: Teague Lasser, Los Angeles, CA (US); Gabriel Lerner, Los Angeles, CA (US); Benjamin Siepser, Los Angeles, CA (US); Jamu Alford, Lake Arrowhead, CA (US); Julian Kates-Harbeck, Marina Del Rey, CA (US); Bryan Johnson, Culver City, CA (US)

(73) Assignee: HI LLC, Los Angeles, CA (US)

(21) Appl. No.: 17/202,459

(22) Filed: Mar. 16, 2021

Related U.S. Application Data
(60) Provisional application No. 62/990,618, filed on Mar. 17, 2020.
(60) Provisional application No. 63/057,479, filed on Jul. 28, 2020.

(51) Int. Cl. G06F 21/32; G06F 3/01; H04L 9/32; G06N 3/02

(52) U.S. Cl. CPC G06F 21/32; G06F 3/015; G06N 3/02; H04L 9/3213; H04L 9/3231

(57) ABSTRACT

An authentication system comprises a brain-computer interface (BCI) configured for detecting neural activity in a brain of a subject in response to the subject performing a repeatable mental task, and outputting neural data representative of the detected neural activity. The authentication system further comprises a computer configured for acquiring the neural data output by the BCI while the subject is performing the repeatable mental task, and generating an authorization request containing the neural data. The authentication system further comprises an authentication processor configured for acquiring the authorization request containing the neural data from the computer, authenticating the subject based on the acquired authorization request, and sending an authorization token to the computer.

### RELATED APPLICATION DATA

Pursuant to 35 U.S.C. § 119(e), this application claims the benefit of U.S. Provisional Application Ser. No. 62/990,618, filed Mar. 17, 2020, and U.S. Provisional Application Ser. No. 63/057,479, filed Jul. 28, 2020, which are expressly incorporated herein by reference.

### FIELD OF THE INVENTION

The present inventions relate to the field of access control, and more specifically, user authentication for access control.

### BACKGROUND OF THE INVENTION

Many digital applications, systems, and/or devices use a form of user authentication for access control, such as to prevent unauthorized access to personal information, resources, services, and the like. The protection and security of customer information is vital from an organization's perspective, not only to comply with applicable laws, but to earn and keep customer's trust.

Security analysts have identified three authentication factors that can be used in making a positive identification: ownership (something only the user has), knowledge (something only the user knows), and inherence (something only the user is), which is conventionally referred to as biometrics. Authentication credentials used to verify the ownership factor may include a phone number, email address, a security token, or a software token. Authentication credentials used to verify the knowledge factor may include a password, username, personal identification number (PIN) or answers to security questions. Classic biometrics may be grouped into physiological and behavioral. Authentication credentials used to verify the physiological inherence factor may include fingerprint, face recognition, DNA prints, palm prints, hand geometry, iris recognition, retinal scans, vein pattern recognition, etc., while authentication credentials used to verify the behavioral inherence factor may include typing rhythm, dynamic signature, walking gait, voiceprints, and eye movement patterns, etc.).

Ownership-based authentication and knowledge-based authentication have been in use for decades and are effective when used carefully. However, these forms of authentication have problems that may weaken their overall effectiveness. In particular, a nefarious third party may steal or otherwise comes into possession of the ownership-based or knowledge-based authentication credentials designed to make a positive identification of the rightful user, and subsequently used to gain unauthorized access. With regard to knowledge-based authentication, the authentication credentials may be stolen surreptitiously and used later by an attacker without the user's knowledge through man-in-the-middle attacks or through social engineering. Knowledge-based authentication that uses passwords also has an inherent complexity trade-off that causes user to favor lower entropy passwords that can be brute-force guessed by determined attackers.

In contrast to ownership-based authentication and knowledge-based authentication, the strengths of inherence-based authentication (biometrics) is that it requires direct physical contact between the user and the authenticating device, and can be used to very quickly identify the user, making it convenient and easy to use. Furthermore, biometrics are unique to each user and, thus, provide a mechanism to reliably identify them, addressing a lack of confidence and assurance in online identities of users. Biometrics provide a natural and single usable interface for user authentication, addressing the requirement of users to maintain dozens of usernames and passwords.

However, the most common forms of inherence-based authentication (biometrics) used today are still vulnerable to a physical attack vector. For example, fingerprint scanners can be attacked with a latex dummy of a user's fingerprint. Face identification systems can be fooled by 3D casts of a user's head. Current biometrics-based identification, authentication and access control systems store the templates of biometrics (whether in clear or in encrypted form) on secure backend servers or databases. Pattern matching or distance measure algorithms are used to compare a users' supplied biometrics when the user interacts with such systems. Although backend servers and databases may be secured through traditional mechanisms of access control (for example, using firewalls), and although biometric templates may be stored in encrypted form, this does not preclude the possibility of a successful attack that infiltrates them and obtains such biometric templates. One successful automated breach of a server or database storing biometric templates can reveal thousands of biometrics which could cause serious risk of massive identity theft and fraud. Once such biometric templates are obtained, a fake biometric may be constructed (though such reconstruction may be easy or hard depending on the specific biometric used, e.g., a fingerprint is easier to replicate than an iris biometric).

Furthermore, typical ownership-based, knowledge-based, and inherent-based authentication systems are not coercion resistant; that is, they cannot defend against coercion attacks that use physical or mental force that coerces the user into transferring authentication credentials to the attacker for the simple reason that an authentication credential that a user owns can be given to another, an authentication credential that a user knows can be told to another, and an authentication credential that is inherent in a user can be examined by another. For example, even if the user has a long and random alphanumeric password, and supplements the authentication using biometrics, such as a fingerprint, an attacker may gain unauthorized access by forcing the user to authenticate himself or herself through the authentication system. In another scenario, there may be cases where a user could claim that they were coerced into giving up the authentication credentials, whereas in reality they acted as an insider attacker.

An authentication system that relies on an automatic brain response of a user to a stimulus is still vulnerable to coercion attacks. There, thus, remains a need to maximize the coercion-resistance of a behavioral authentication system.

### SUMMARY OF THE INVENTION

In accordance with a first aspect of the present inventions, an authentication system comprises a brain-computer interface (BCI) configured for detecting neural activity in a brain of a subject in response to the subject performing a repeatable mental task, and outputting neural data (which may comprise a plurality of neural data samples) representative of the detected neural activity. In one embodiment, the BCI comprises an optical measurement assembly. In another embodiment, the BCI comprises a magnetic measurement assembly. In still another embodiment, the BCI comprises at least one detector configured for detecting energy from the brain of the user, and processing circuitry configured for identifying the neural activity in response to detecting the energy from the brain of the user. In this case, the BCI may comprise a head-worn unit carrying the at least one energy source. The BCI may also comprise an auxiliary non-head-worn unit carrying the processing circuitry.

The authentication system further comprises a computer configured for acquiring the neural data output by the BCI while the subject is performing the repeatable mental task. In one embodiment, the neural data output by the BCI is encrypted. In one embodiment, the neural data output by the BCI is raw neural data, and the computer is configured for creating one or more non-fungible tokens (NFTs) from the raw neural data output by the BCI. In another embodiment, the computer is configured for prompting the subject to perform the repeatable mental task. For example, prompting the subject to perform the repeatable mental task may comprise one or more of requesting the subject to think of something, requesting the subject to solve a difficult math problem, telling a joke to the subject, and requesting the subject to laugh.

The authentication system further comprises an authentication processor (e.g., a neural network) configured for acquiring the neural data from the computer, authenticating the subject based on the acquired neural data, and sending an authorization token to the computer. If the computer creates NFTs from the raw neural data output by the BCI, the neural data acquired from the computer by the authentication processor may comprise NFTs. In one embodiment, the authentication system comprises a security enclave comprising the authentication processor. In another embodiment, the computer is configured for generating an authorization request containing the neural data, and the authentication processor is configured for acquiring the authorization request containing the neural data from the computer, and authenticating the subject based on the acquired authorization request. In still another embodiment, the authentication system further comprises a keystore containing one or more keys. In this case, the computer is configured for using the authentication token to unlock the keystore, retrieve the key(s) from the keystore, and access one or more resources using the retrieved key(s).

In yet another embodiment, the authentication system further comprises a database that stores a neural activity signature of the subject. In this case, the authentication processor may be configured for retrieving the neural activity signature of the subject from the database, comparing the neural data acquired by the computer to the retrieved neural activity signature of the subject, and authenticating the subject based on the comparison. The neural activity signature may comprise at least one vector of known identification features, in which case, the authentication processor may be configured for extracting a vector of features from the neural data acquired by the computer, comparing the neural data acquired by the computer to the retrieved neural activity signature of the subject by comparing the extracted vector of features to the at least one vector of known identification features, and authenticating the subject if the extracted vector of features matches the at least one vector of known identification features.

In accordance with a second aspect of the present inventions, a method of authenticating a subject comprises performing a repeatable mental task in the subject. One method further comprises prompting the subject to perform the repeatable mental task. For example, prompting the subject to perform the repeatable mental task may comprise one or more of requesting the subject to think of something, requesting the subject to solve a difficult math problem, telling a joke to the subject, and requesting the subject to laugh.

The method further comprises detecting brain activity (e.g., optically or magnetically) of the subject in response to the subject performing the repeatable mental task, outputting neural data (e.g., a plurality of neural data samples) representative of the detected neural activity. In one method, the brain activity of the user comprises detecting energy from a brain of the user, and identifying the brain activity in response to detecting the energy from the brain of the user. One method further comprises encrypting the neural data. In one method, the outputted neural data is raw neural data, and the method further comprises creating one or more non-fungible tokens (NFTs) from the outputted raw neural data.

The method further comprises authenticating the subject based on the outputted neural data. If NFTs are created from outputted raw neural data, the neural data used to authenticate the subject may comprise NFTs. One method further comprises generating an authorization request containing the neural data, wherein the subject is authenticated in response to the authorization request, and generating an authorization token in response to authenticating the subject. This method may further comprise using the authentication token to unlock a keystore, retrieving one or more keys from the keystore, and accessing one or more resources using the retrieved key(s).

One method further comprises storing a neural activity signature of the subject, retrieving the neural activity signature of the subject, and comparing the outputted neural data to the retrieved neural activity signature of the subject, wherein the subject is authenticated based on the comparison. In this method, the neural activity signature may comprise at least one vector of known identification features, in which case, the method may further comprise extracting a vector of features from the outputted neural data, comparing the outputted neural data to the retrieved neural activity signature of the subject by comparing the extracted vector of features to the at least one vector of known identification features, and authenticating the subject if the extracted vector of features matches the one vector of known identification features.

In accordance with a third aspect of the present inventions, an authentication system comprises a brain-computer interface (BCI) configured for detecting neural activity in a brain of a subject in response to the subject performing a repeatable mental task, and outputting a time series of neural data samples representative of the detected neural activity.

The authentication system further comprises a computer configured for acquiring the time series of neural data samples output by the BCI while the subject is performing the repeatable mental task. In one embodiment, the computer is configured for prompting the subject to perform the repeatable mental task. The authentication system further comprises a database and an authentication processor configured for generating an account for the subject, deriving a neural activity signature of the subject from the time series of neural data samples output by the BCI, linking the neural activity signature to the account, and storing the neural activity signature in the database.

In one embodiment, the authentication processor is configured for comparing one of the time series of neural data samples output by the BCI to the neural activity signature, and finalizing the account for the subject based on the comparison. This authentication processor may be further configured for updating the neural activity signature with the one neural data sample if the one neural data sample matches the neural activity signature. The updated neural activity signature may comprise a plurality of the neural data samples, in which case, the authentication processor may be configured for computing an error between the plurality of neural data samples, comparing the error to a threshold value, and finalizing the account for the subject if the error is less than the threshold value. If the error is greater than the threshold value, the authentication processor may be configured for determining if error of the updated neural activity signature has decreased relative to an error between the plurality of neural data samples of the neural activity signature prior to updating the neural activity signature. The authentication processor may be configured for clearing the account if the error of the updated neural activity signature has not increased, and for comparing another one of the time series of neural data samples output by the BCI to the neural activity signature if the error of the updated neural activity signature has increased.

In accordance with a fourth aspect of the present inventions, a method of setting up an account for a user comprises performing a repeatable mental task in the subject, and detecting brain activity of the subject in response to the subject performing the repeatable mental task. One method further comprises prompting the subject to perform the repeatable mental task.

The method further comprises outputting a time series of neural data samples representative of the detected neural activity, generating an account for the subject, deriving a neural activity signature of the subject from the time series of neural data samples, linking the neural activity signature to the account, and storing the neural activity signature.

One method further comprises comparing one of the time series of neural data samples to the neural activity signature, and finalizing the account for the subject based on the comparison. This method may further comprise updating the neural activity signature with the one neural data sample if the one neural data sample matches the neural activity signature. The updated neural activity signature may comprise a plurality of the neural data samples, in which case, the method may further comprise computing an error between the plurality of neural data samples, comparing the error to a threshold value, and finalizing the account for the subject if the error is less than the threshold value. If the error is greater than the threshold value, the method may further comprise determining if error of the updated neural activity signature has decreased relative to an error between the plurality of neural data samples of the neural activity signature prior to updating the neural activity signature. This method may further comprise clearing the account if the error of the updated neural activity signature has not increased, and comparing another one of the time series of neural data samples to the neural activity signature if the error of the updated neural activity signature has increased.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the present inventions and are not therefore to be considered limiting of its scope, the present inventions will be described and explained with additional specificity and detail through the use of the accompanying drawings in which:

FIG. 1 is a block diagram of an authentication system constructed in accordance with one embodiment of the present inventions;

FIG. 2 is a flow diagram of one method of operating the authentication system of FIG. 1 to authenticate a subject;

FIG. 3 is a block diagram of a data processing pipeline employed by a secure enclave of the authentication system of FIG. 1 to authenticate the subject;

FIG. 4 is a flow diagram of one method of establishing a repeatable mental task in the authentication system of FIG. 1;

FIG. 5 is a view of one specific physical embodiment of the authentication system of FIG. 1;

FIG. 6 is a view of another specific physical embodiment of the authentication system of FIG. 1;

FIGS. 7A-7D are views of exemplary non-invasive wearable devices as used with the system of FIG. 6;

FIG. 8 is a view of still another specific physical embodiment of the authentication system of FIG. 1; and

FIGS. 9A-9C illustrate exemplary non-invasive wearable devices as used with the system of FIG. 1.

### DETAILED DESCRIPTION OF THE EMBODIMENTS

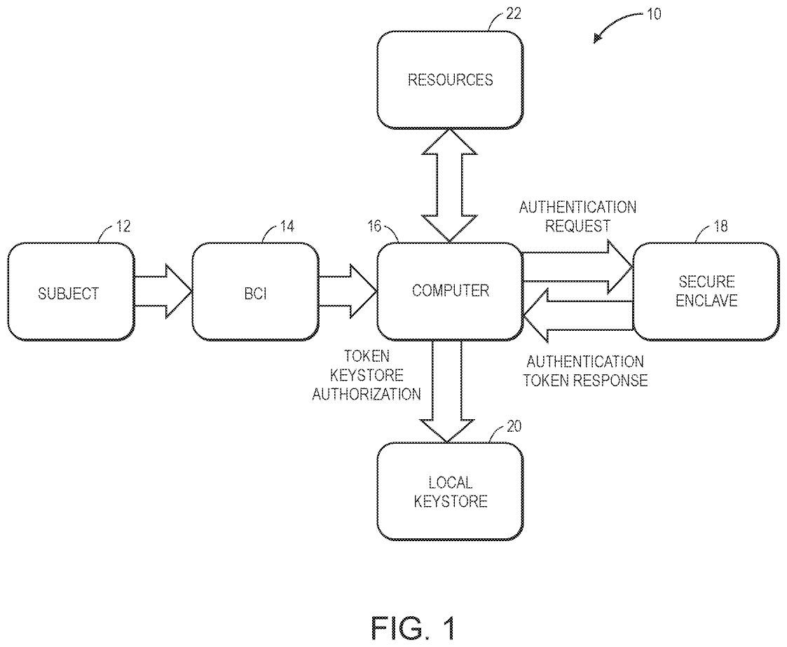

Referring to FIG. 1, one embodiment of an authentication system 10 will now be described. The authentication system 10 comprises a brain computer interface (BCI) 14 that is configured for detecting neural activity in the brain of the subject 12 in response to the subject 12 performing a repeatable mental task, and outputting encrypted data representative of the neural activity. The repeatable mental task will establish the coercion resistance of the authentication system 10. In particular, the subject 12 is requested by the authentication system 10 to perform a mental task, which serves as an authentication credential. The repeatable mental task may active or passive with various peripheral inputs (audio, visual). Examples of repeatable mental tasks may be, e.g., asking the subject 12 to think of something (e.g., an objective, scene, memory, etc.), requesting the subject 12 to solve a difficult math problem, telling a joke to the subject 12, etc.

The neural activity detected by the BCI 14 is correlated to the repeatable mental task, such that it is an accurate representation of the repeatable mental task. In the preferred embodiment, the neural activity detected by the BCI 14 in response to the subject 12 performing the mental task serves as a unique signature (i.e., it is unique to the performance of repeatable mental task by the subject 12 in the same manner as a finger print is unique to the subject 12). For example, a functional connectome (i.e., correlations between different brain areas during resting state or during mental tasks) can be highly personalized, yet also highly predictable for a given individual (see Emily S. Finn, et al., “Functional Connectome Fingerprinting: Identifying Individuals Using Patterns of Brain Connectivity,” Natural Neuroscience 18, 1664-1671 (2015) (https://www.nature.com/articles/nn.4135); Julia de Souza Rodrigues, et al., “Identifying Individuals Using fNIRS-Based Cortical Connectomes,” Biomed Opt Express. 2019 Jun. 1; (10)6: 2889-2897 (https://www.ncbi.nlm.nih.gov/pmc/articles/PMC6583329); Ekansh Sareen, et al., “Exploring MEG Brain Fingerprints; Evaluation, Pitfalls and Interpretations,” (Feb. 16, 2021) (doi: https://doi.org/10.1101/2021.02.15.431253). The BCI 14 may be any suitable BCI that is capable of non-invasively acquiring hi-fidelity neural activity from the brain of the subject 12. The BCI 14 is also known as a neural-controlled interface (NCI), mind-machine interface (MMI), direct neural interface (DNI), or brain-machine interface (BMI)), which detects the neural data from the brain of the subject 12.

For example, in one embodiment, the BCI 14 may incorporate any one or more of the optically-based neural activity detection technologies as described more fully below. As another example, a magnetically-based non-invasive BCI 14 configured for magnetically detecting neural activity in the brain 14 of the subject 12 may be used as described more fully below.

The BCI 14 may employ sensor system-on-chip (SoC) technology to acquire the neural data. However, there is no requirement that the sensors of the BCI 14 be built into a chip. For example, the BCI 14 may employ field programmable gate arrays (FPGAs) that can emulate SoCs or a microcontroller that serves the same task of sampling from an analog-to-digital converter (ADC).

The authentication system 10 further comprises a computer 16, a secure enclave 18, and a keystore 20. The computer 16 is configured for acquiring the encrypted neural data from the BCI 14 and sending an authorization request containing the encrypted neural data to the secure enclave 18. In alternative embodiments, the neural data output by the BCI 14 is not encrypted; however, doing so improves the tamper resistance of the authentication system 10.

In one embodiment, the computer 16 may generate a non-fungible token (NFT) from the neural data acquired from the BCI 14 to create a unique and personalized representation of the user's 12 mind, and send the authorization request, along with the NFTs, to the secure enclave 18. The neural data acquired from the BCI 14 may be represented in a variety of manners, including two-dimensional (2D) activations spatially mapped on the surface of the cortex that are static or potentially changing over time three-dimensional (3D) activations spatially mapped throughout the brain that are static or potentially changing over time; direct time series from a multitude of sensors (sensor space); correlations and connections between various neural sources or regions (represented as a correlation matrix, connectivity graph, or mathematical derivation thereof (connectivity space), etc. In order to obtain these representations, various forms of signal processing and source reconstructions (for the 2D and 3D neural data) can be applied to the raw neural data. The representations can then be visualized or otherwise captured in a variety of manners (e.g., 2D static image, 2D video, 3D static image, 3D video, interactive exploration (including with a virtual reality (VR) system or an augmented reality (AR) system) of, e.g., 3D activations, non-visual representations (raw data, conversion of time series to audio, network connectivity represented as a connectivity graph, etc.), which renderings can then be used to generate the NFTs.

The secure enclave 18 analyzes the neural data (e.g., the NFTs) sent by the computer 16 to positively identify the subject 12, and upon such positive identification, sends an authentication token response back to the computer 16. In one embodiment, the secure enclave 18 comprises an authentication processor for performing this authentication function. For the purposes of this specification, a secure enclave is a trusted execution environment for processing sensitive data. Thus, the secure enclave 18 defines a zone of trust (i.e., the secure enclave 18 is safe from tampering and its results cannot be observed by a third party) for the processing of the neural data and the subsequent generation of the authentication token once the subject 12 has been positively identified.

The computer 16 may then use the authentication token to gain access to the keystore 20, such that the subject 12 may access the resources 22 (e.g., information, services, and the like). The keystore 20 is an encrypted vault that stores secrets and encryption keys; in other words, the keystore 20 contains the local credentials for accounts that the subject 12 controls. Authorization for accessing a keystore is typically granted in response to the use of a correct password manually entered by a subject. However, in this embodiment, authorization to access the keystore 20 is granted by the token returned from the secure enclave 18.

In the illustrated embodiment, the local keystore 20 comprises storage that is remote from the computer 16, and the secure enclave 18 comprises one or more processors that are remote from the computer 16. However, in alternative embodiments, the local keystore 20 may be contained in memory of the computer 16 and/or the secure enclave 18 may be contained in the computer 16 as a co-processor (separate from the CPU that acquires the encrypted neural data from the BCI 14 and sends the authorization request containing the encrypted neural data to the secure enclave 18).

Although the authentication system 10 is described as authenticating a subject 12 based only on neural activity acquired from the brain of the subject 12, it should be appreciated that the authentication system 10 can comprise multiple layers that authenticate the subject 12 additionally based on other authentication procedures (e.g., the use of an alphanumeric password or other types of biometrics).

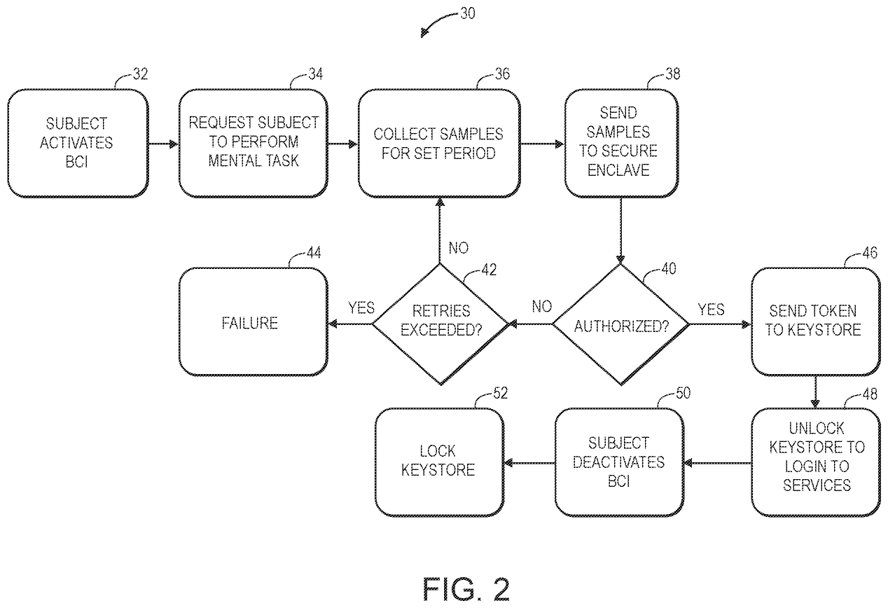

Referring to FIG. 2, one exemplary method 30 for performing an authentication procedure on the subject 12 will now be described. The subject 12 activates the BCI 14, e.g., by wearing the BCI 14 on subject's head, connecting the BCI 14 (via a wired or wireless connection) to the computer 16, and turning on the BCI 14 (step 32). The computer 16 requests the subject 12 to perform the mental task (step 34). The BCI 14 collects a time series of neural data samples from the subject 12 as the subject is performing the mental task over a set period (step 36). The computer 16 receives the neural data samples from the BCI 14 and sends them to the secure enclave 18 (step 38). The secure enclave 18 then authorizes (i.e., positively identifies) the subject 12 based on the neural data samples received from the computer 16 (step 40). If the secure enclave 18 does not authorize the subject 12, another authorization attempt or attempts may be required. In particular, the computer 16 determines whether a number of retries has been exceeded (step 42). If the number of retries has been exceeded (step 42), the computer 16 deems the authentication attempt to be a failure (step 44). If a failure attempt is determined, the authentication session will be aborted. If the number of retries has not been exceeded, steps 36-42 are repeated for the next time period. If at step 40, the secure enclave 18 authorizes the subject 12 based on the neural data samples received from the computer 16 during any authorization attempt, the authorization token is sent to the computer 16 (step 46), and the computer 16 unlocks the keystore 20 to login into the service (step 48). The subject 12 may then deactivate the BCI 14 (step 50), and the computer 16 may then lock the keystore 20 (step 52).

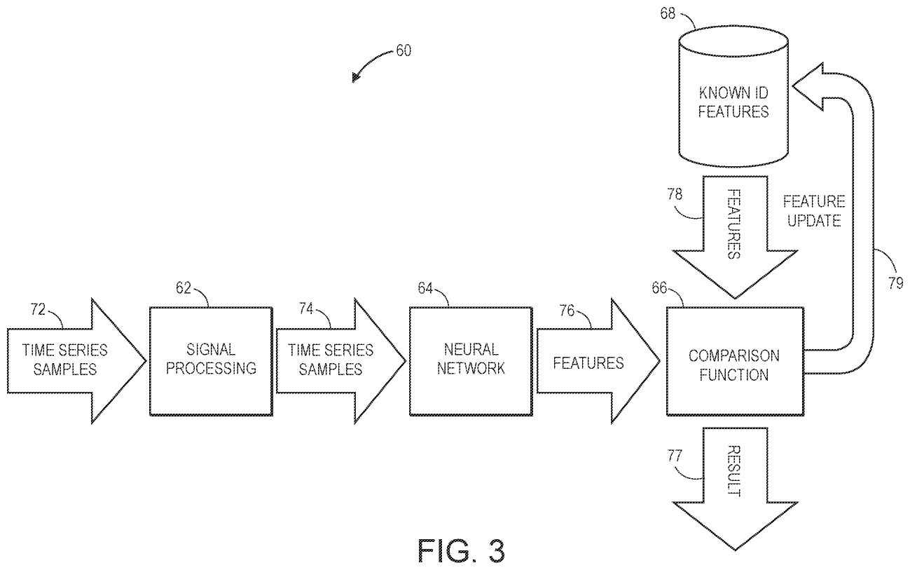

Referring to FIG. 3, one data pipeline 60 employed in the secure enclave 18 to authorize the subject 12 based on the time series of neural data samples 72 received from the computer 16 will now be described. The secure enclave 18 comprises a signal processing function 62 that first processes the time series of neural data samples 72 received from the computer 16 and outputs a time series of processed neural data samples 74. The authentication processor of the secure enclave 18 takes the form of a neural network 64 that extracts a vector of features 76 from the time series of processed neural data samples 74. In the illustrated embodiment, the neural network 64 accomplishes this extraction function by transforming the very high-dimensional vector of the neural data samples 74 into a lower dimensional feature vector (the “qualities” of the neural activity).

The secure enclave 18 further comprises a comparison function 66 that compares the feature vector 76 extracted by the neural network 64 to one or more vectors of known identification features 78 (i.e., the neural activity signature) contained in a database 68 to generate a result 77 (authorization or no authorization) based on the comparison. That is, if the feature vector 76 extracted by the neural network 64 matches the known identification feature vector(s) 78 stored in the database 68 to a degree, the result 77 returned by the secure enclave 18 will be a positive identification of the subject 12 (authorization), and in contrast, if the feature vector 76 extracted by the neural network 64 does not match the known identification feature vector(s) 718 contained in the database 68 to a degree, the result 77 returned by the secure enclave 18 will not be a positive identification of the subject 12 (no authorization). In this manner, the known identification feature vector(s) 78 stored in the database 68 serves as a neural activity signature that is unique to the subject 12. In the illustrated embodiment, the comparison function 66 compares the feature vector 76 extracted by the neural network 64 to the known identification feature vector(s) 78 in a “nearest neighbors” sense. As will be described in further detail below, the comparison function 66 may have an update function 79 that updates the known identification feature vector(s) 78. The database 68 may be located within the secure enclave 18, itself, or may be located remotely from the secure enclave 18. In one embodiment, the stored known identification feature vector(s) 78 to which the feature vector 76 extracted by the neural network 64 is compared are derived from several neural data samples, as described in further detail below.

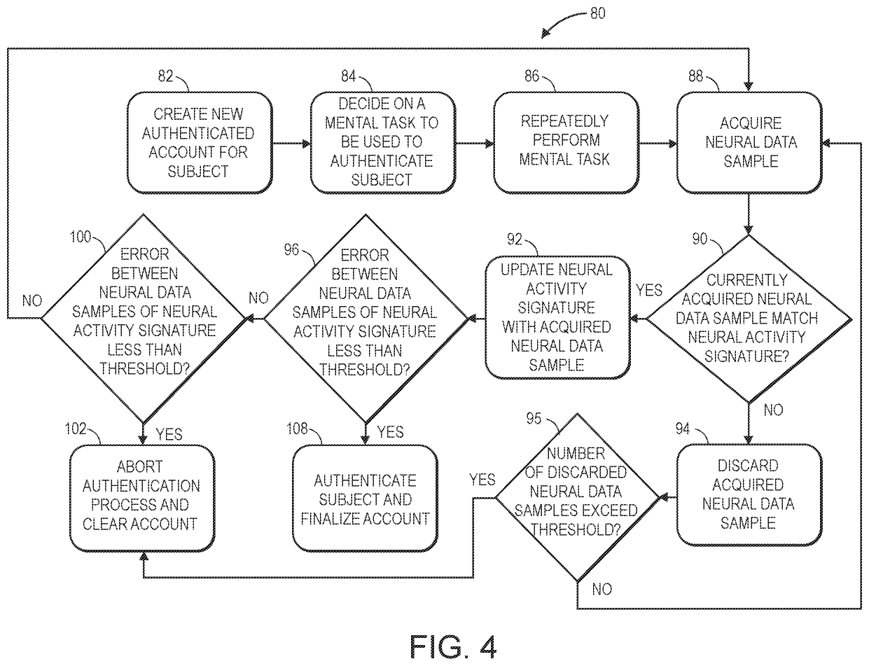

Referring to FIG. 4, one method 80 for establishing the repeatable mental task will now be described. Notably, the initial setup of the authentication system 10 is important from an accuracy standpoint if the BCI 14 is not well situated (e.g., the contact between the detectors of the BCI 14 and the subject 12 is insufficient or unstable) or badly calibrated. If the authentication system 10 is not properly set up, the repeatable mental task performed by the subject 12 may not be detectable by the BCI 14. Thus, it is important that, while being performed by the subject 12, the repeatable mental task correlates with the detected neural activity, meaning that the same regions of the brain of the subject 12 are becoming active when the subject 12 performed the repeatable mental task. If the mental task performed by the subject 12 is not repeatably detectable due to noise in the BCI 14, then the performance of the authentication system 10 will be degraded. If the neural data samples acquired by the BCI 14 are not clustered closely together in quality in some bounded threshold of performance, this is a good indication that there is too much noise in the authentication system 10, and thus, the repeatable mental task performed by the subject 12 may not be able to be accurately measured. Thus, it is important that the accuracy of the authentication system 10 improves (i.e., that the neural data samples acquired by the BCI 14 be close to each other and not vastly separated in quality).

To this end, the computer 16 first creates a new authenticated account for the subject 12 (step 82). The subject 12 decides on a mental task to be used to authenticate himself/herself (step 84), and repeatedly performs the mental task while wearing the BCI 14 (step 86). While the subject is repeatedly performing the mental task, the computer 16 acquires a time series of neural data samples, and the secure enclave 18 generates a neural activity signature from the time series of neural data samples, links the neural activity signature to the account of the subject 12, and stores the linked neural activity signature and account in the database 68 (shown in FIG. 3).

In the illustrated embodiment, the secure enclave 18 generates the neural activity signature by respectively extracting vectors of features from the neural data samples, and comparing the feature vectors of the neural data samples to each other in a “nearest neighbors” sense, such that the neural activity signature comprises a plurality of weighted feature vectors. The feature vectors are weighted in such a manner that neural activity data with similar properties sits closely together in this lower dimensional manifold defined by the feature space; that is, the data samples that are better by some metric provide the centroid (the center of the region of interest in feature-space) and the distance (like the radius of a sphere) that a neural data sample is allowed to be from the center for a match to be accepted. This allows simpler algorithms (such as support vector machine (SVM)) to divide the feature space up into regions where patterns of neural activity lie closer together. Thus, the neural activity signature that is stored in the database 68 will comprise a weighted combination of feature vectors extracted from the time series of neural data samples.

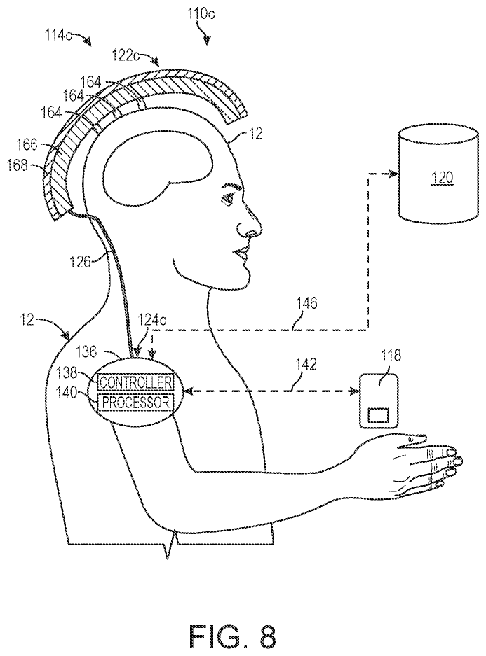

In the illustrated embodiment, in response to the subject 12 performing the mental task, the secure enclave 18 acquires a current neural data sample from the BCI 14 (shown in FIG. 8) (step 88). In one embodiment, the secure enclave 108 extracts a vector of features from the acquired neural data sample (e.g., via the neural network 64). The secure enclave 18 then determines if the currently acquired neural data sample matches the neural activity signature previously stored in the database 68, and in this case, whether the feature vector extracted from the currently acquired neural data sample is contained within the feature-space hyperspheroid of the neural activity signature (step 90).

In the illustrated embodiment, the neural activity signature is generated from a plurality of weighted neural data samples, and in this case, from the weighted feature vectors extracted from the neural data samples. The weighting can be a normal average (i.e., all 1's) or weighted by an algorithm, such as a sampling time that favors neural data samples acquired more recently than older neural data samples. Notably, if the currently acquired neural data sample is the initial one acquired from the BCI 14, this initial neural data sample will simply be stored in the database 68 as the initial neural activity signature. In the illustrated embodiment, the currently acquired neural data sample is deemed to match the neural activity signature if the feature vector extracted from the currently acquired neural data sample is contained within an acceptance hyperspheroid in the feature-space of the neural activity signature.

If the currently acquired neural data sample matches the previously stored neural activity signature, the secure enclave 18 updates the neural activity signature previously stored in the database 68 (step 92). The neural activity signature may be updated by an objective function that defines optimization criteria. In the illustrated embodiment, the update of the neural activity signature results in the change of the centroid and radius of an acceptance hyperspheroid in the feature-space.

The secure enclave 18 then determines if the error between the weighted neural data samples of the neural activity signature is less than a threshold value (step 96). In the illustrated embodiment, the neural activity signature error is computed as a function of the radii of the hyperspheroid and the centroid (weighted average of the neural data samples) of the hyperspheroid. If the error between the weighted neural data samples of the neural activity signature is less than the threshold value, the secure enclave 18 authenticates the subject 12 and finalizes the account (step 98).

If the error between the weighted neural data samples of the neural activity signature is equal to or greater than the threshold value, the secure enclave 18 instead determines if the error between the weighted neural data samples of the updated neural activity signature has improved (i.e., decreased) relative to the error between the weighted neural data samples of the neural activity signature prior to the update (step 100). If the error between the weighted neural data samples of the updated neural activity signature has not improved, the secure enclave 18 aborts the authentication process and clears the account (step 102). If the error between the weighted neural data samples of the updated neural activity signature has improved, the secure enclave 18, in response to the subject 12 performing the mental task, acquires the next neural data sample from the BCI 14 (step 88), and the authentication process repeats for that neural data sample.

If the currently acquired neural data sample does not conform to the previously established neural activity signature at step 90, the neural data sample is discarded without updating the neural activity signature stored in the database 68 (step 94). The security enclave 18 determines if a number of discarded neural data samples has exceeded a threshold number (e.g., a number in the range of 5 to 10) (step 95), and if so, the secure enclave 18 aborts the authentication process and clears the account (step 102). If the number of discarded neural data samples has not exceeded the threshold number at step 95, the secure enclave 18, in response to the subject 12 performing the mental task, acquires the next neural data sample from the BCI 14 (step 88), and the authentication process repeats for that neural data sample.

Thus, it can be appreciated that the authentication system 10 overcomes the challenges faced by the conventional authentication systems, such as ownership-based, knowledge-based, and inherence-based authentication systems. Furthermore, the authentication system 10 retains high information entropy in authentication (defeats brute-force attacks). The authentication system 10 may bootstrap encryption of an entire BCI session. The authentication system 10 is useful in singularly identifying a subject while maintaining anonymity for cryptographically secure transactions (such as the exchange of cryptocurrency).

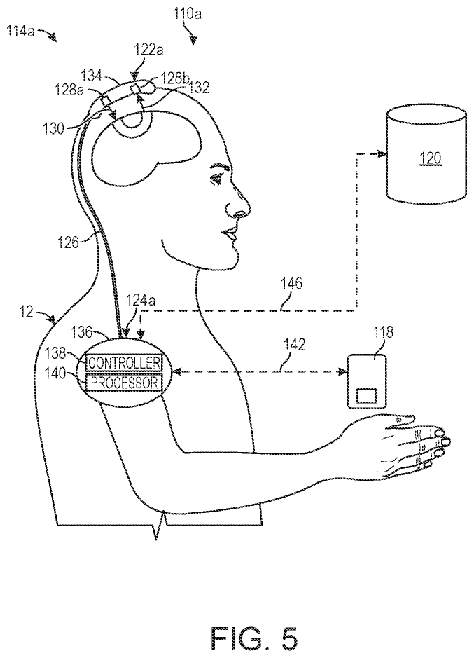

Referring to FIG. 5, a physical implementation of one embodiment of authentication system 110a that may embody the authentication system 10 illustrated in FIG. 1 will now be described. The authentication system 110a comprises an optically-based non-invasive BCI 114a configured for optically detecting neural activity in the brain 14 of the subject 12. The non-invasive BCI 114a may, e.g., incorporate any one or more of the neural activity detection technologies described in U.S. patent application Ser. No. 15/844,370, entitled “Pulsed Ultrasound Modulated Optical Tomography Using Lock-In Camera” (now U.S. Pat. No. 10,335,036), U.S. patent application Ser. No. 15/844,398, entitled “Pulsed Ultrasound Modulated Optical Tomography With Increased Optical/Ultrasound Pulse Ratio” (now U.S. Pat. No. 10,299,682), U.S. patent application Ser. No. 15/844,411, entitled “Optical Detection System For Determining Neural Activity in Brain Based on Water Concentration” (now U.S. Pat. No. 10,420,469), U.S. patent application Ser. No. 15/853,209, entitled “System and Method For Simultaneously Detecting Phase Modulated Optical Signals” (now U.S. Pat. No. 10,016,137), U.S. patent application Ser. No. 15/853,538, entitled “Systems and Methods For Quasi-Ballistic Photon Optical Coherence Tomography In Diffusive Scattering Media Using a Lock-In Camera” (now U.S. Pat. No. 10,219,700), U.S. patent application Ser. No. 16/266,818, entitled “Ultrasound Modulating Optical Tomography Using Reduced Laser Pulse Duration,” U.S. patent application Ser. No. 16/299,067, entitled “Non-Invasive Optical Detection Systems and Methods in Highly Scattering Medium,” U.S. patent application Ser. No. 16/379,090, entitled “Non-Invasive Frequency Domain Optical Spectroscopy For Neural Decoding,” U.S. patent application Ser. No. 16/382,461, entitled “Non-Invasive Optical Detection System and Method,” U.S. patent application Ser. No. 16/392,963, entitled “Interferometric Frequency-Swept Source And Detector In A Photonic Integrated Circuit,” U.S. patent application Ser. No. 16/392,973, entitled “Non-Invasive Measurement System and Method Using Single-Shot Spectral-Domain Interferometric Near-Infrared Spectroscopy Based On Orthogonal Dispersion, U.S. patent application Ser. No. 16/393,002, entitled “Non-Invasive Optical Detection System and Method Of Multiple-Scattered Light With Swept Source Illumination,” U.S. patent application Ser. No. 16/385,265, entitled “Non-Invasive Optical Measurement System and Method for Neural Decoding,” U.S. patent application Ser. No. 16/533,133, entitled “Time-Of-Flight Optical Measurement And Decoding Of Fast-Optical Signals,” U.S. patent application Ser. No. 16/565,326, entitled “Detection Of Fast-Neural Signal Using Depth-Resolved Spectroscopy,” U.S. patent application Ser. No. 16/226,625, entitled “Spatial and Temporal-Based Diffusive Correlation Spectroscopy Systems and Methods,” U.S. Provisional Application Ser. No. 62/772,584, entitled “Diffuse Correlation Spectroscopy Measurement Systems and Methods,” U.S. patent application Ser. No. 16/432,793, entitled “Non-Invasive Measurement Systems with Single-Photon Counting Camera,” U.S. Provisional Application Ser. No. 62/855,360, entitled “Interferometric Parallel Detection Using Digital Rectification and Integration,” U.S. Provisional Application Ser. No. 62/855,380, entitled “Interferometric Parallel Detection Using Analog Data Compression,” and U.S. Provisional Application Ser. No. 62/855,405, entitled “Partially Balanced Interferometric Parallel Detection,” which are all expressly incorporated herein by reference.

The BCI 114a includes a wearable unit 122a configured for being applied to the subject 12, and in this case, worn on the head of the subject 12; and an auxiliary head-worn or non-head-worn unit 124a (e.g., worn on the neck, shoulders, chest, or arm). Alternatively, the functionality of the non-head-worn unit 124a may be incorporated into the head-worn unit 122a. The auxiliary non-head-worn unit 124a may be coupled to the head-worn unit 122a via a wired connection 126 (e.g., electrical wires). Alternatively, the BCI 114a may use a non-wired connection (e.g., wireless radio frequency (RF) signals (e.g., Bluetooth, Wifi, cellular, etc.) or optical links (e.g., fiber optic or infrared (IR)) for providing power to or communicating between the respective head-worn unit 122a and the auxiliary unit 124a.

The head-worn unit 122a comprises electronic or optical components, such as, e.g., one or more optical sources, an interferometer, one or more optical detector(s) (not shown), etc., an output port 128a for emitting sample light 130 generated by the BCI 114a into the head of the subject 12, an input port 128b configured for receiving neural-encoded signal light 132 from the head of the subject 12, which signal light is then detected, modulated and/or processed to determine brain activity of the subject 12, and a support housing structure 134 containing the electronic or optical components, and ports 128a, 128b.

The support housing structure 134 may be shaped, e.g., have a banana, headband, cap, helmet, beanie, other hat shape, or other shape adjustable and conformable to the user's head, such that the ports 128a, 128b are in close contact with the outer skin of the head, and in this case, the scalp of the subject 12. The support housing structure 134 may be made out of any suitable cloth, soft polymer, plastic, hard shell, and/or any other suitable material as may serve a particular implementation. In an alternative embodiment, optical fibers (not shown) may be respectively extended from the ports 128a, 128b, thereby freeing up the requirement that the ports 128a, 128b be disposed in close proximity to the surface of the head. In any event, an index matching fluid may be used to reduce reflection of the light generated by the head-worn unit 122a from the outer skin of the scalp. An adhesive, strap, or belt (not shown) can be used to secure the support housing structure 134 to the head of the subject 12.

The auxiliary unit 124a comprises a housing 136 containing a controller 138 and a processor 140. The controller 138 is configured for controlling the operational functions of the head-worn unit 122a, whereas the processor 140 is configured for processing the neural-encoded signal light 132 acquired by the head-worn unit 122a to detect and localize the brain activity of the subject 12. The auxiliary unit 124a may additionally include a power supply (which if head-worn, may take the form of a rechargeable or non-chargeable battery), a control panel with input/output functions, a display, and memory. Alternatively, power may be provided to the auxiliary unit 124a wirelessly (e.g., by induction).

The authentication system 110a comprises a peripheral device 118 (e.g., a Smartphone, tablet computer, or the like) that contains the functionality of the computer 16, although in alternative embodiments, at least some of the processing functions of computer 16 can be performed in other processing components, such as the processor 140 of the auxiliary unit 124a. The peripheral device 118 is coupled to the auxiliary unit 124a of the BCI 114a via a wireless connection 142 (e.g., wireless radio frequency (RF) signals (e.g., Bluetooth, Wifi, cellular, etc.) or optical links (e.g., fiber optic or infrared (IR)) for communicating between the peripheral device 118 and the BCI 114a. Alternatively, wired connections between the peripheral device 118 and the BCI 114a may be used. The peripheral device 118 may be coupled to the secure enclave 18, local keystore 20, and resources 22 if not contained within the peripheral device 118, itself, via one or more communication links (not shown in FIG. 5).

The database, server, or cloud structure 120 may be coupled to the auxiliary unit 124a of the BCI 114a (and/or the peripheral device 118) via a wireless connection 146 (e.g., wireless radio frequency (RF) signals (e.g., Bluetooth, Wifi, cellular, etc.) or optical links (e.g., fiber optic or infrared (IR)) for communicating between the database, server, or cloud structure 120 and the BCI 114a and peripheral device 118. Alternatively, a wired connection between the database, server, or cloud structure 120 and the auxiliary unit 124a of the BCI 114a and/or the peripheral device 118 may be used in the case where additional or supplemental computational power is required.

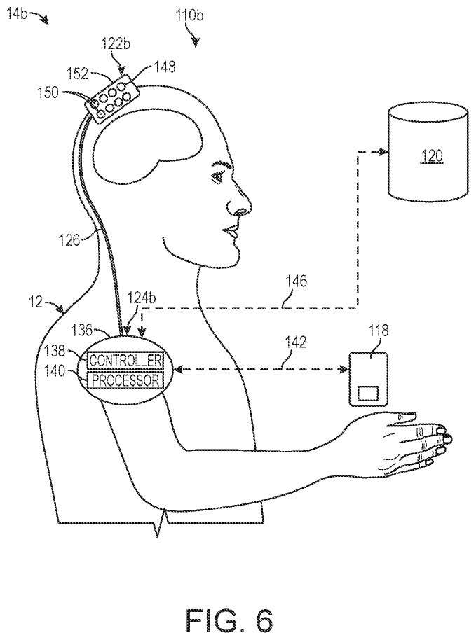

Referring to FIG. 6, a physical implementation of another embodiment of an authentication system 110b that may embody the authentication system 10 illustrated in FIG. 1 will now be described.

The authentication system 110b comprises an optically-based, time-domain, non-invasive BCI 114b configured for optically detecting neural activity in the brain 14 of the subject 12. Example time domain-based optical measurement techniques include, but are not limited to, time-correlated single-photon counting (TCSPC), time domain near infrared spectroscopy (TD-NIRS), time domain diffusive correlation spectroscopy (TD-DCS), and time domain Digital Optical Tomography (TD-DOT). The non-invasive BCI 114b may, e.g., incorporate any one or more of the neural activity detection technologies described in U.S. Non-Provisional application Ser. No. 16/051,462, entitled “Fast-Gated Photodetector Architecture Comprising Dual Voltage Sources with a Switch Configuration” (now U.S. Pat. No. 10,158,038), U.S. patent application Ser. No. 16/202,771, entitled “Non-Invasive Wearable Brain Interface Systems Including a Headgear and a Plurality of Self-Contained Photodetector Units Configured to Removably Attach to the Headgear” (now U.S. Pat. No. 10,340,408), U.S. patent application Ser. No. 16/283,730, entitled “Stacked Photodetector Assemblies” (now U.S. Pat. No. 10,515,993), U.S. patent application Ser. No. 16/544,850, entitled “Wearable Systems with Stacked Photodetector Assemblies” (now U.S. Pat. No. 10,847,563), U.S. patent application Ser. No. 16/844,860, entitled “Photodetector Architectures for Time-Correlated Single Photon Counting,” U.S. patent application Ser. No. 16/852,183, entitled “Photodetector Architectures for Efficient Fast-Gating,” U.S. patent application Ser. No. 16/880,686, entitled “Photodetector Systems with Low-Power Time-To-Digital Converter Architectures” (now U.S. Pat. No. 10,868,207), U.S. Provisional Application Ser. No. 62/979,866 entitled “Optical Module Assemblies,” U.S. Provisional Application Ser. No. 63/038,485 entitled “Control Circuit for a Light Source in an Optical Measurement System,” U.S. Provisional Application Ser. No. 63/040,773 entitled “Multiplexing Techniques for Interference Reduction in Time-Correlated Signal Photon Counting,” U.S. Provisional Application Ser. No. 63/064,249 entitled “Maintaining Consistent Photodetector Sensitivity in an Optical Measurement System,” U.S. Provisional Application Ser. No. 63/027,018 entitled “Phase Lock Loop Circuit Based Adjustment of a Measurement Time Window in an Optical Measurement System,” U.S. Provisional Application Ser. No. 63/044,521 entitled “Techniques for Determining a Timing Uncertainty of a Component of an Optical Measurement System,” U.S. Provisional Application Ser. No. 63/059,382 entitled “Techniques for Characterizing a Nonlinearity of a Time-To-Digital Converter in an Optical Measurement System,” U.S. Provisional Application Ser. No. 63/027,025 entitled “Temporal Resolution Control for Temporal Point Spread Function Generation in an Optical Measurement System,” U.S. Provisional Application Ser. No. 63/057,080 entitled “Bias Voltage Generation in an Optical Measurement System,” U.S. Provisional Application Ser. No. 63/051,099 entitled “Detection of Motion Artifacts in Signals Output by Detectors of a Wearable Optical Measurement System,” U.S. Provisional Application Ser. No. 63/057,077 entitled “Dynamic Range Optimization in an Optical Measurement System,” U.S. Provisional Application Ser. No. 63/074,721 entitled “Maintaining Consistent Photodetector Sensitivity in an Optical Measurement System,” U.S. Provisional Application Ser. No. 63/070,123 entitled “Photodetector Calibration of an Optical Measurement System,” U.S. Provisional Application Ser. No. 63/071,473 entitled “Estimation of Source-Detector Separation in an Optical Measurement System,” U.S. Provisional Application Ser. No. 63/081,754 entitled “Wearable Module Assemblies for an Optical Measurement System,” U.S. Provisional Application Ser. No. 63/086,350 entitled “Wearable Devices and Wearable Assemblies with Adjustable Positioning for Use in an Optical Measurement System,” U.S. Provisional Application Ser. No. 63/038,459 entitled “Integrated Detector Assemblies for a Wearable Module of an Optical Measurement System,” U.S. Provisional Application Ser. No. 63/038,468 entitled “Detector Assemblies for a Wearable Module of an Optical Measurement System and Including Spring-Loaded Light-Receiving Members,” U.S. Provisional Application Ser. No. 63/038,481 entitled “Integrated Light Source Assembly with Laser Coupling for a Wearable Optical Measurement System,” U.S. Provisional Application Ser. No. 63/079,194 entitled “Multimodal Wearable Measurement Systems and Methods,” U.S. Provisional Application Ser. No. 63/064,688 entitled “Time Domain-Based Optical Measurement System and Method Configured to Measure Absolute Properties of Tissue,” U.S. Provisional Application Ser. No. 63/138,159 entitled “Systems and Methods for Noise Removal in an Optical Measurement System,” and U.S. Provisional Application Ser. No. 63/030,199 entitled “Time Resolved Histogram Data Compression and Dimensionality Reduction for Data Transfer, Optical Parameter Recovery, and Image Reconstruction,” and Han Y. Ban, et al., “Kernel Flow: A High Channel Count Scalable TD-fNIRS System,” SPIE Photonics West Conference (Mar. 6, 2021), which are all expressly incorporated herein by reference in their entirety.

The BCI 114b includes a head-worn unit 122b that is configured for being applied to the subject 12, and in this case, worn on the head of the subject 12; and an auxiliary non-head-worn unit 124b (e.g., worn on the neck, shoulders, chest, or arm). Alternatively, the functionality of the non-head-worn unit 124b may be incorporated into the head-worn unit 122b, as described below. The auxiliary non-head-worn unit 124b may be coupled to the head-worn unit 122b via a wired connection 126 (e.g., electrical wires). Alternatively, the BCI 114b may use a non-wired connection (e.g., wireless radio frequency (RF) signals (e.g., Bluetooth, Wifi, cellular, etc.) or optical links (e.g., fiber optic or infrared (IR)) for providing power to or communicating between the respective head-worn unit 122b and the auxiliary unit 124b.

The head-worn unit 122b includes one or more light sources 148 configured for generating light pulses. The light source(s) 148 may be configured for generating one or more light pulses at one or more wavelengths that may be applied to a desired target (e.g., a target within the brain). The light source(s) 148 may be implemented by any suitable combination of components. For example, light source(s) 148 described herein may be implemented by any suitable device. For example, a light source as used herein may be, for example, a distributed feedback (DFB) laser, a super luminescent diode (SLD), a light emitting diode (LED), a diode-pumped solid-state (DPSS) laser, a laser diode (LD), a super luminescent light emitting diode (sLED), a vertical-cavity surface-emitting laser (VCSEL), a titanium sapphire laser, a micro light emitting diode (mLED), and/or any other suitable laser or light source.

The head-worn unit 122b includes a plurality of photodetector units 150, e.g., comprising single-photon avalanche diodes (SPADs) configured for detecting a single photon (i.e., a single particle of optical energy) in each of the light pulses. For example, an array of these sensitive photodetector units can record photons that reflect off of tissue within the brain in response to application of one or more of the light pulses generated by the light sources 148. Based on the time it takes for the photons to be detected by the photodetector units, neural activity and other attributes of the brain can be determined or inferred.

Photodetector units that employ the properties of a SPAD are capable of capturing individual photons with very high time-of-arrival resolution (a few tens of picoseconds). When photons are absorbed by a SPAD, their energy frees bound charge carriers (electrons and holes) that then become free-carrier pairs. In the presence of an electric field created by a reverse bias voltage applied to the diode, these free-carriers are accelerated through a region of the SPAD, referred to as the multiplication region. As the free carriers travel through the multiplication region, they collide with other carriers bound in the atomic lattice of the semiconductor, thereby generating more free carriers through a process called impact ionization. These new free-carriers also become accelerated by the applied electric field and generate yet more free-carriers. This avalanche event can be detected and used to determine an arrival time of the photon. In order to enable detection of a single photon, a SPAD is biased with a reverse bias voltage having a magnitude greater than the magnitude of its breakdown voltage, which is the bias level above which free-carrier generation can become self-sustaining and result in a runaway avalanche. This biasing of the SPAD is referred to as arming the device. When the SPAD is armed, a single free carrier pair created by the absorption of a single photon can create a runaway avalanche resulting in an easily detectable macroscopic current.

It will be recognized that in some alternative embodiments, the head-worn unit 122b may include a single light source 148 and/or single photodetector unit 150. For example, the brain interface system 114b may be used for controlling a single optical path and for transforming photodetector pixel measurements into an intensity value that represents an optical property of a brain tissue region. In some alternative embodiments, the head-worn unit 122b does not include individual light sources. Instead, a light source configured to generate the light that is detected by the photodetector may be included elsewhere in the brain interface system 114b. For example, a light source may be included in the auxiliary unit 124b. In alternative embodiments, a module assembly may house the photodetector units 150 and the light source 148 in the same assembly and eliminate the need for long fiber optic cables. For example, head-worn unit 122b may include the wearable modular assembly wherein the wearable modular assembly includes a plurality of connectable wearable modules. Each wearable module includes a light source 148 configured to emit a light pulse toward a target within the brain of the user and a plurality of photodetector units 150 configured to receive photons included in the light pulse after the photons are scattered by the target. The wearable module assemblies can conform to a 3D surface of the user's head, maintain tight contact of the detectors with the user's head to prevent detection of ambient light, and maintain uniform and fixed spacing between light sources 148 and photodetector units 150. The wearable module assemblies may also accommodate a large variety of head sizes, from a young child's head size to an adult head size, and may accommodate a variety of head shapes and underlying cortical morphologies through the conformability and scalability of the wearable module assemblies. These exemplary modular assemblies and systems are described in more detail in U.S. Provisional Application Nos. 63/038,459; 63/038,468; 63/038,481; 63/064,688; 63/081,754; and 63/086,350, previously incorporated herein by reference.

The head-worn unit 122b further comprises a support housing structure 152 containing the light source(s) 148, photodetector units 150, and other electronic or optical components. In alternative embodiments, the housing structure 152 may include a single module assembly containing a single light source 148, plurality of photodetector units 150, and other electronic or optical components. In other alternative embodiments, the housing structure 152 may include a plurality of module assemblies tiled together, wherein each module assembly includes the light source 148, plurality of photodetector units 150, and other electronic or optical components. As will be described in further detail below, the support housing structure 152 may be shaped, e.g., have a banana, headband, cap, helmet, beanie, other hat shape, or other shape adjustable and conformable to the user's head, such that the photodetector units 150 are in close contact with the outer skin of the head, and in this case, the scalp of the subject 12. The support housing structure 152 may be made out of any suitable cloth, soft polymer, plastic, hard shell, and/or any other suitable material as may serve a particular implementation.

While brain interface system 114b shows one head-word unit 122b, any suitable number of head-worn units 122b may be used, for instance at different locations on the head.

The auxiliary unit 124b comprises the housing 136 containing the controller 138 and the processor 140. The controller 138 is configured for controlling the operational functions of the head-worn unit 122b, whereas the processor 140 is configured for processing the photons acquired by the head-worn unit 122b to detect and localize the detected neural activity 24 of the subject 12. The auxiliary unit 124b may additionally include a power supply (which if head-worn, may take the form of a rechargeable or non-chargeable battery), a control panel with input/output functions, a display, and memory. Alternatively, power may be provided to the auxiliary unit 124b wirelessly (e.g., by induction).

The authentication system 110b further comprises the peripheral device 118 and the database, server, or cloud structure 120, which can function and be coupled to each other and to the secure enclave 18, local keystore 20, and resources 22 in the same manner described above with respect to the authentication system 110a.

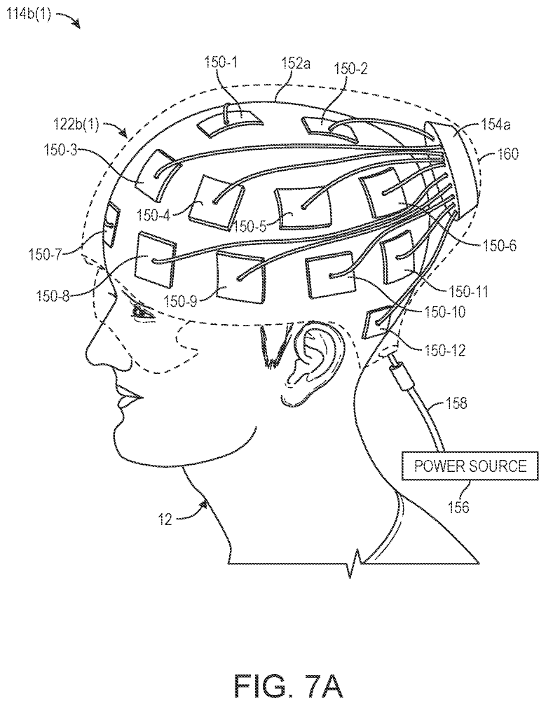

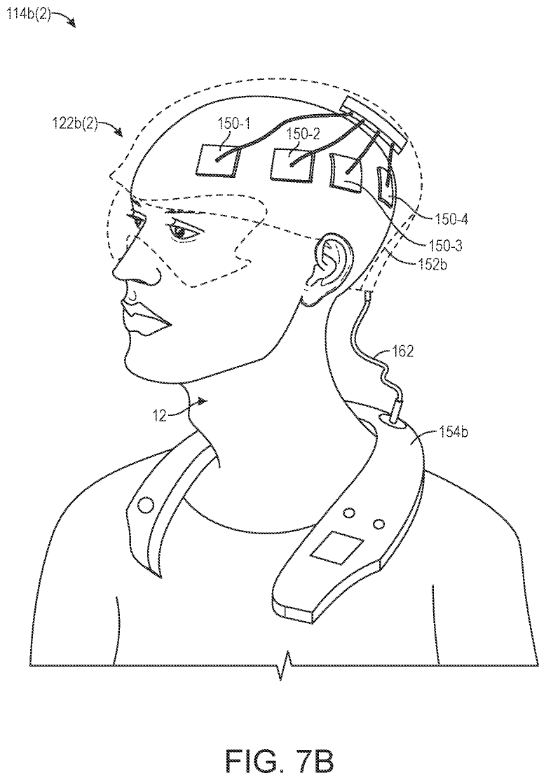

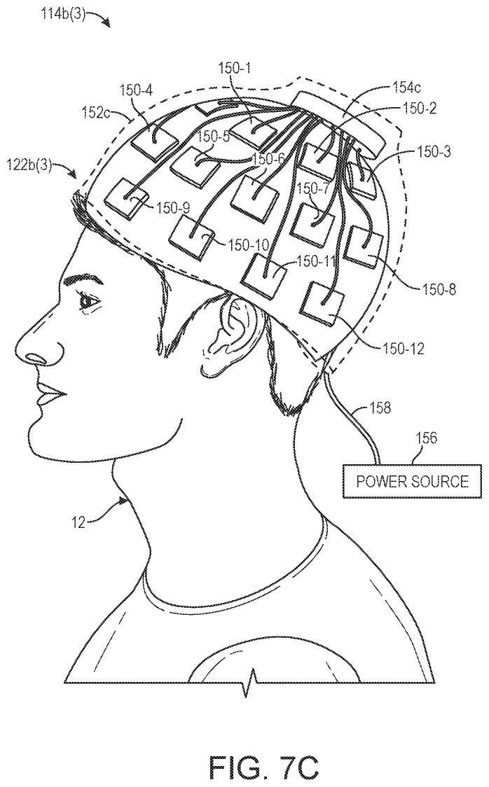

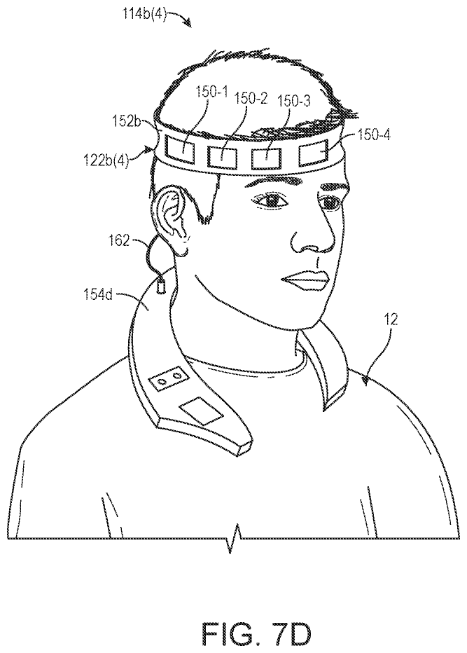

Referring now to FIGS. 7A-7D, different embodiments of the BCI 114b will be described. Such brain interface assemblies 114b may communicate wirelessly or via wire with the peripheral device 118 and database, server, cloud structure 120, as described above. Each of the brain interface assemblies 114b described below comprises a head-worn unit 122b having a plurality of photodetector units 150 and a support housing structure 152 in which the photodetector units 150 are embedded within individual slots or cut-outs. Each of the photodetector units 150 may comprise, e.g., a SPAD, voltage sources, capacitors, switches, and any other circuit components and other optical components (not shown) required to detect photons. Each of the brain interface assemblies 114b may also comprise one or more light sources (not shown) for generating light pulses, although the source of such light may be derived from ambient light in some cases. In alternative embodiments, the light source may be a component contained within of the photodetector units. Each of brain interface assemblies 114b may also comprise a control/processing unit 154, such as, e.g., a control circuit, time-to-digital (TDC) converter, and signal processing circuit for controlling the operational functions of the photodetector units 150 and any light source(s), and processing the photons acquired by photodetector units 150 to detect and localize the brain activity of the subject 12. As will be described in further detail below, the control/processing unit 154 may be contained in the head-worn unit 122b or may be incorporated into a self-contained auxiliary unit. As will be set forth below, the support housing structure 152 may be shaped, e.g., have a banana, headband, cap, helmet, beanie, other hat shape, or other shape adjustable and conformable to the user's head, such that the photodetector units 150 are in close contact with the outer skin of the head, and in this case, the scalp of the subject 12.

As shown in FIG. 7A, a BCI 114b(1) comprises a head-worn unit 122b(1) and a power source 156 coupled to the head-worn unit 122b(1) via a power cord 158. The head-worn unit 122b(1) includes the photodetector units 150 (shown as 150-1 through 150-12) and a control/processing unit 154a. The head-worn unit 122b(1) further includes a support housing structure 152a that takes a form of a cap that contains the photodetector units 150 and control/processing unit 154a. The material for the cap 152a may be selected out of any suitable cloth, soft polymer, plastic, hard shell, and/or any other suitable material as may serve a particular implementation. The power source 156 may be implemented by a battery and/or any other type of power source configured to provide operating power to the photodetector units 150, control/processing unit 154a, and any other component included within the BCI 122b(1) via the power cord 158. The head-worn unit 122b(1) optionally includes a crest or other protrusion 160 formed in the cap 152a for providing means of carrying/housing a control/processing unit 154a.

As shown in FIG. 7B, a BCI 114b(2) comprises a head-worn unit 122b(2) and a control/processing unit 154b coupled to the head-worn unit 122b(2) via a wired connection 162. The head-worn unit 122b(2) includes the photodetector units 150 (shown as 150-1 through 150-4), and a support housing structure 152b that takes a form of a helmet containing the photodetector units 150. The material for the helmet 152b may be selected out of any suitable polymer, plastic, hard shell, and/or any other suitable material as may serve a particular implementation. Unlike the control/processing unit 154a of the BCI 114b(1) illustrated in FIG. 7A, which is contained in the head-worn unit 122b(1), the control/processing unit 154b is self-contained, and may take the form of a garment (e.g., a vest, partial vest, or harness) for being worn on the shoulders of the subject 12. The self-contained control/processing unit 154b may additionally include a power supply (which if head-worn, may take the form of a rechargeable or non-chargeable battery), a control panel with input/output functions, a display, and memory. Alternatively, power may be provided to the self-contained control/processing unit 154b wirelessly (e.g., by induction).

As shown in FIG. 7C, a BCI 114b(3) comprises a head-worn unit 122b(3) and a power source 156 coupled to the head-worn unit 122b(3) via a power cord 174. The head-worn unit 122b(3) includes the photodetector units 150 (shown as 150-1 through 150-12) and a control/processing unit 154c. The head-worn unit 122b(3) further includes a support housing structure 152c that takes a form of a beanie that contains the photodetector units 150 and control/processing unit 154c. The material for the beanie 152c may be selected out of any suitable cloth, soft polymer, plastic, and/or any other suitable material as may serve a particular implementation. The power source 156 may be implemented by a battery and/or any other type of power source configured to provide operating power to the photodetector units 150, control/processing unit 154c, and any other component included within the BCI 122b(3) via a wired connection 158.

As shown in FIG. 7D, a BCI 114b(4) comprises a head-worn unit 122b(4) and a control/processing unit 154d coupled to the head-worn unit 122b(4) via a wired connection 162. The head-worn unit 122b(4) includes the photodetector units 150 (shown as 150-1 through 150-4), and a support housing structure 152d that takes a form of a headband containing the photodetector units 150. The material for the headband 152d may be selected out of any suitable cloth, soft polymer, plastic, hard shell, and/or any other suitable material as may serve a particular implementation. The control/processing unit 154d is self-contained, and may take the form of a garment (e.g., a vest, partial vest, or harness) for being worn on the shoulders of the subject 12. The self-contained control/processing unit 154d may additionally include a power supply (which if head-worn, may take the form of a rechargeable or non-chargeable battery), a control panel with input/output functions, a display, and memory. Alternatively, power may be provided to the self-contained control/processing unit 154d wirelessly (e.g., by induction).

Referring to FIG. 8, a physical implementation of still another embodiment of a system 110c that may embody the authentication system 10 illustrated in FIG. 1 will now be described.

The authentication system 110c comprises a magnetically-based non-invasive BCI 114c configured for magnetically detecting neural activity in the brain 14 of the subject 12. Example techniques of using the magnetically-based non-invasive BCI 114c are directed to the area of magnetic field measurement systems including systems for magnetoencephalography (MEG). The non-invasive BCI 114c may, e.g., incorporate any one or more of the neural activity detection technologies described in U.S. patent application Ser. No. 16/428,871, entitled “Magnetic Field Measurement Systems and Methods of Making and Using,” U.S. patent application Ser. No. 16/418,478, entitled “Magnetic Field Measurement System and Method of Using Variable Dynamic Range Optical Magnetometers,” U.S. patent application Ser. No. 16/418,500, entitled, “Integrated Gas Cell and Optical Components for Atomic Magnetometry and Methods for Making and Using,” U.S. patent application Ser. No. 16/457,655, entitled “Magnetic Field Shaping Components for Magnetic Field Measurement Systems and Methods for Making and Using,” U.S. patent application Ser. No. 16/213,980, entitled “Systems and Methods Including Multi-Mode Operation of Optically Pumped Magnetometer(S),” (now U.S. Pat. No. 10,627,460), U.S. patent application Ser. No. 16/456,975, entitled “Dynamic Magnetic Shielding and Beamforming Using Ferrofluid for Compact Magnetoencephalography (MEG),” U.S. patent application Ser. No. 16/752,393, entitled “Neural Feedback Loop Filters for Enhanced Dynamic Range Magnetoencephalography (MEG) Systems and Methods,” U.S. patent application Ser. No. 16/741,593, entitled “Magnetic Field Measurement System with Amplitude-Selective Magnetic Shield,” U.S. patent application Ser. No. 16/820,131, entitled “Integrated Magnetometer Arrays for Magnetoencephalography (MEG) Detection Systems and Methods,” U.S. patent application Ser. No. 16/850,380, entitled “Systems and Methods for Suppression of Interferences in Magnetoencephalography (MEG) and Other Magnetometer Measurements,” U.S. patent application Ser. No. 16/850,444 entitled “Compact Optically Pumped Magnetometers with Pump and Probe Configuration and Systems and Methods,” U.S. Provisional Application Ser. No. 62/842,818 entitled “Active Shield Arrays for Magnetoencephalography (MEG),” U.S. patent application Ser. No. 16/928,810 entitled “Systems and Methods for Frequency and Wide-Band Tagging of Magnetoencephalography (MEG) Signals,” U.S. patent application Ser. No. 16/984,720 entitled “Systems and Methods for Multiplexed or Interleaved Operation of Magnetometers,” U.S. patent application Ser. No. 16/984,752 entitled “Systems and Methods having an Optical Magnetometer Array with Beam Splitters,” U.S. patent application Ser. No. 17/004,507 entitled “Methods and Systems for Fast Field Zeroing for Magnetoencephalography (MEG),” U.S. patent application Ser. No. 16/862,826 entitled “Single Controller for Wearable Sensor Unit that Includes an Array Of Magnetometers,” U.S. patent application Ser. No. 16/862,856 entitled “Systems and Methods for Measuring Current Output By a Photodetector of a Wearable Sensor Unit that Includes One or More Magnetometers,” U.S. patent application Ser. No. 16/862,879 entitled “Interface Configurations for a Wearable Sensor Unit that Includes One or More Magnetometers,” U.S. patent application Ser. No. 16/862,901 entitled “Systems and Methods for Concentrating Alkali Metal Within a Vapor Cell of a Magnetometer Away from a Transit Path of Light,” U.S. patent application Ser. No. 16/862,919 entitled “Magnetic Field Generator for a Magnetic Field Measurement System,” U.S. patent application Ser. No. 16/862,946 entitled “Magnetic Field Generator for a Magnetic Field Measurement System,” U.S. patent application Ser. No. 16/862,973 entitled “Magnetic Field Measurement Systems Including a Plurality of Wearable Sensor Units Having a Magnetic Field Generator,” U.S. Provisional Application Ser. No. 62/975,709 entitled “Self-Calibration of Flux Gate Offset and Gain Drift To Improve Measurement Accuracy of Magnetic Fields from the Brain Using a Wearable System,” U.S. Provisional Application Ser. No. 62/975,693 entitled “Nested and Parallel Feedback Control Loops for Ultra-Fine Measurements of Magnetic Fields from the Brain Using a Wearable MEG System,” U.S. Provisional Application Ser. No. 62/975,719 entitled “Estimating the Magnetic Field at Distances from Direct Measurements to Enable Fine Sensors to Measure the Magnetic Field from the Brain Using a Wearable System,” U.S. Provisional Application Ser. No. 62/975,723 entitled “Algorithms that Exploit Maxwell's Equations and Geometry to Reduce Noise for Ultra-Fine Measurements of Magnetic Fields from the Brain Using a Wearable MEG System,” U.S. Provisional Application Ser. No. 62/975,727 entitled “Optimal Methods to Feedback Control and Estimate Magnetic Fields to Enable a Wearable System to Measure Magnetic Fields from the Brain,” U.S. Provisional Application Ser. No. 62/983,406 entitled “Two Level Magnetic Shielding of Magnetometers,” U.S. Provisional Application Ser. No. 63/076,015 entitled “Systems and Methods for Recording Neural Activity,” U.S. Provisional Application Ser. No. 63/058,616 entitled “OPM Module Assembly with Alignment and Mounting Components as Used in a Variety of Headgear Arrangements,” U.S. Provisional Application Ser. No. 63/076,880 entitled “Systems and Methods for Multimodal Pose and Motion Tracking for Magnetic Field Measurement Or Recording Systems,” U.S. Provisional Application Ser. No. 63/140,150 entitled “Magnetic Field Measurement or Recording Systems with Validation Using Optical Tracking Data,” and U.S. Provisional Application Ser. No. 63/135,364 entitled “Devices, Systems, Methods with Optical Pumping Magnetometers for Three-Axis Magnetic Field Sensing,” and Ethan J. Pratt, et al., “Kernel Flux: A Whole-Head 432-Magnetometer Optically-Pumped Magnetoencephalography (OP-MEG) System for Brain Activity Imaging During Natural Human Experiences,” SPIE Photonics West Conference (Mar. 6, 2021), which are all expressly incorporated herein by reference in their entirety.

The BCI 114c includes a magnetoencephalography (MEG) head-worn unit 122c that is configured for being applied to the subject 12, and in this case, worn on the head of the subject 12; and an auxiliary non-head-worn unit 124c (e.g., worn on the neck, shoulders, chest, or arm). Alternatively, the functionality of the non-head-worn unit 124c may be incorporated into the head-worn unit 122c, as described below. The auxiliary non-head-worn unit 124c may be coupled to the head-worn unit 122c via a wired connection 126 (e.g., electrical wires). Alternatively, the BCI 114c may use a non-wired connection (e.g., wireless radio frequency (RF) signals (e.g., Bluetooth, Wifi, cellular, etc.) or optical links (e.g., fiber optic or infrared (IR)) for providing power to or communicating between the respective head-worn unit 122c and the auxiliary unit 124c.

The head-worn unit 122c includes a plurality of optically pumped magnetometers (OPMs) 164 or other suitable magnetometers to measure biologically generated magnetic fields from the brain of the subject 12 and a passive shield 166 (and/or flux concentrators). By placing the passive shield 166 over the head of the subject 12, the ambient background magnetic field arising from areas outside the passive shield 166 is greatly decreased and the OPMs 164 can measure or detect magnetic fields from activity occurring in the brain of the subject 12 due to the reduction in the ambient background magnetic field.

An OPM is an optical magnetometry system used to detect a magnetic field that propagates through the human head. Optical magnetometry can include the use of optical methods to measure a magnetic field with very high accuracy-on the order of 1×10⁻¹⁵ Tesla. Of particular interest for their high-sensitivity, an OPM can be used in optical magnetometry to measure weak magnetic fields. (The Earth's magnetic field is typically around 50 micro Tesla). In at least some systems, the OPM has an alkali vapor gas cell that contains alkali metal atoms in a combination of gas, liquid, or solid states (depending on temperature). The gas cell may contain a quenching gas, buffer gas, or specialized anti-relaxation coatings or any combination thereof. The size of the gas cells can vary from a fraction of a millimeter up to several centimeters, allowing the practicality of OPMs to be used with wearable non-invasive brain interface devices.

The head-worn unit 122c further comprises a support housing structure 168 containing the OPMs 164, passive shield 166, and other electronic or magnetic components. As will be described in further detail below, the support housing structure 168 may be shaped, e.g., have a banana, headband, cap, helmet, beanie, other hat shape, or other shape adjustable and conformable to the user's head, such that the OPMs 164 are in close contact with the outer skin of the head, and in this case, the scalp of the subject 12. The support housing structure 168 may be made out of any suitable cloth, soft polymer, plastic, hard shell, and/or any other suitable material as may serve a particular implementation.

The head-worn unit 122c may also include a plurality of optically pumped magnetometer (OPM) modular assemblies, which OPM modular assemblies are enclosed within the head-worn unit 122c. The OPM modular assembly is designed to enclose the elements of the OPM optics, vapor cell, and detectors in a compact arrangement that can be positioned close to the head of the human subject. The head-worn unit 122c may also include an adjustment mechanism used for adjusting the head-worn unit 122c to conform with the human subject's head. These exemplary OPM modular assemblies and systems are described in more detail in U.S. Provisional Application Ser. No. 63/058,616, previously incorporated by reference. The magnetically-based head-worn unit 122c can also be used in a magnetically shielded environment with an open entryway which can allow for user movement as described for example in U.S. Provisional Application Ser. No. 63/076,015, previously incorporated by reference. User tracking movement in a magnetically shielded environment can include an optical user pose identification system and/or other sensing modalities as described more fully in U.S. Provisional Application Ser. Nos. 63/076,880 and 63/135,364, previously incorporated herein by reference.

The auxiliary unit 124c comprises the housing 136 containing the controller 138 and the processor 140. The controller 138 is configured for controlling the operational functions of the head-worn unit 122c, whereas the processor 140 is configured for processing the magnetic fields detected by the head-worn unit 122c to detect and localize the detected neural activity 24 of the subject 12. The auxiliary unit 124c may additionally include a power supply (which if head-worn, may take the form of a rechargeable or non-chargeable battery), a control panel with input/output functions, a display, and memory. Alternatively, power may be provided to the auxiliary unit 124c wirelessly (e.g., by induction).

The authentication system 110c further comprises the peripheral device 118 and the database, server, or cloud structure 120, which can function and be coupled to each other and to the secure enclave 18, local keystore 20, and resources 22 in the same manner described above with respect to the authentication system 110a.

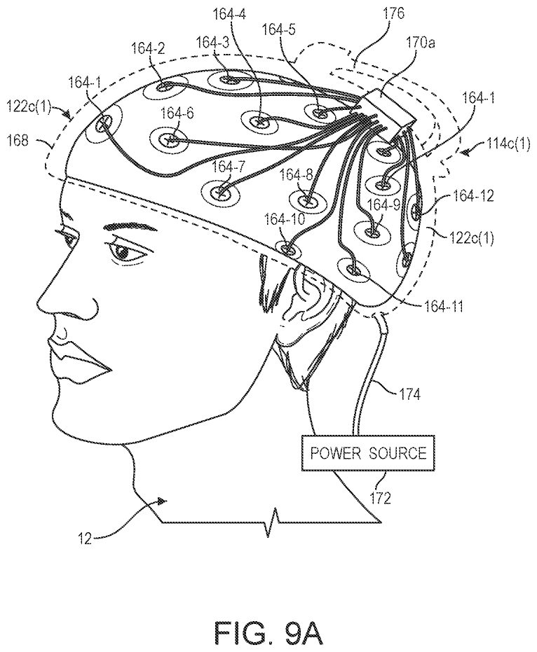

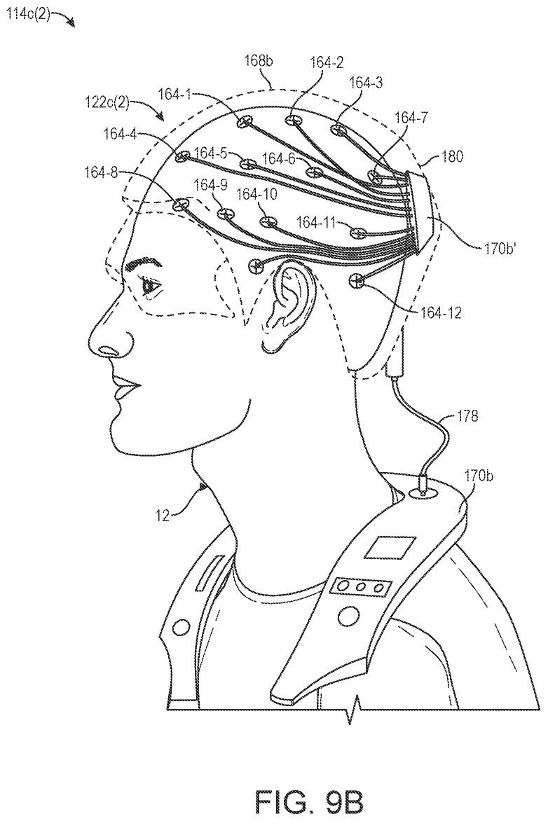

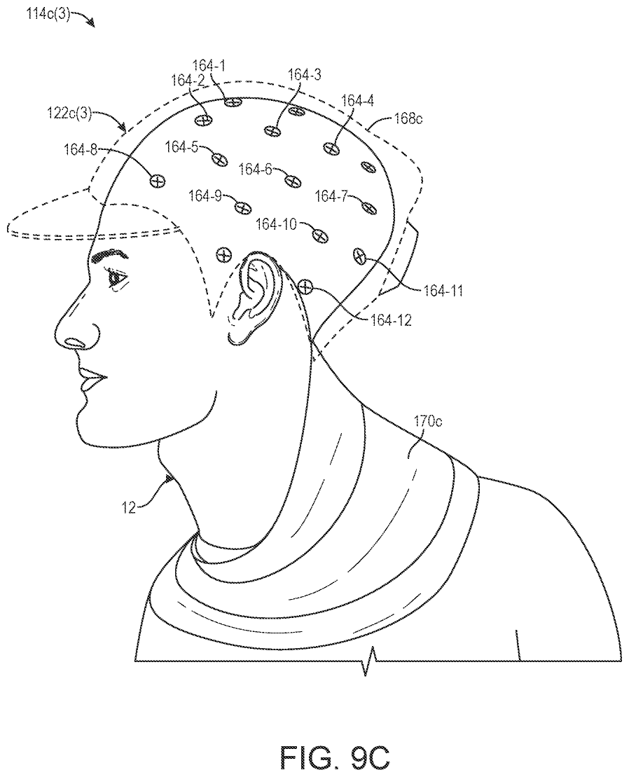

Referring now to FIGS. 9A-9C, different embodiments of the BCI 114c will be described. Such brain interface assemblies 114c may communicate wirelessly or via wire with the peripheral device 118 and database, server, cloud structure 120, as described above. Each of the brain interface assemblies 114c described below comprises a head-worn unit 122c having a plurality of OPMs 164, a passive shield 166, and a support housing structure 168 in which the OPMs 164 and passive shield 166 are embedded. Each of brain interface assemblies 114c may also comprise a control/processing unit 170 for controlling the operational functions of the OPMs 164, and processing the magnetic fields detected by the OPMs 164 to detect and localize the brain activity of the subject 12. As will be described in further detail below, the control/processing unit 170 may be contained in the head-worn unit 122c or may be incorporated into a self-contained auxiliary unit. As will be set forth below, the support housing structure 168 may be shaped, e.g., have a banana, headband, cap, helmet, beanie, other hat shape, or other shape adjustable and conformable to the user's head, such that the OPMs 164 are in close contact with the outer skin of the head, and in this case, the scalp of the subject 12.

As shown in FIG. 9A, a BCI 114c(1) comprises a head-worn unit 122c(1) and a power source 172 coupled to the head-worn unit 122c(1) via a wired connection 174. The head-worn unit 122c(1) includes the OPMs 164 (shown as 164-1 through 164-12) and a control/processing unit 170a. The head-worn unit 122c(1) further includes a support housing structure 168a that takes a form of a helmet that contains the OPMs 164, passive shield 166, and control/processing unit 170a. The material for the helmet 168a may be selected out of any suitable cloth, soft polymer, plastic, hard shell, and/or any other suitable material as may serve a particular implementation. The power source 172 may be implemented by a battery and/or any other type of power source configured to provide operating power to the OPMs 164, control/processing unit 170a, and any other component included within the BCI 122c(1) via the wired connection 174. The head-worn unit 122c(1) optionally includes a handle 176 affixed to the helmet 168a for providing a convenient means of carrying the head-worn unit 122c(1).

As shown in FIG. 9B, a BCI 114c(2) comprises a head-worn unit 122c(2) and a control/processing unit 170b coupled to the head-worn unit 122b(2) via a wired connection 178. The head-worn unit 122c(2) includes the OPMs 164 (shown as 164-1 through 164-12), and a support housing structure 168b that takes a form of a helmet that contains the OPMs 164 and passive shield 166. The material for the helmet 168b may be selected out of any suitable cloth, soft polymer, plastic, hard shell, and/or any other suitable material as may serve a particular implementation. Unlike the control/processing unit 170a of the BCI 114c(1) illustrated in FIG. 9A, which is contained in the head-worn unit 122c(1), the control/processing unit 170b is self-contained, and may take the form of a garment (e.g., a vest, partial vest, or harness) for being worn on the shoulders of the subject 12. The self-contained control/processing unit 170b may additionally include a power supply (which if head-worn, may take the form of a rechargeable or non-chargeable battery), a control panel with input/output functions, a display, and memory. Alternatively, power may be provided to the self-contained control/processing unit 170b wirelessly (e.g., by induction). The head-worn unit 122c(1) optionally includes a crest or other protrusion 180 formed in the helmet 168b for providing means of carrying a control/processing unit 170b′.

As shown in FIG. 9C, a BCI 114c(3) comprises a head-worn unit 122c(3) and a control/processing unit 170c. The head-worn unit 122c(3) includes the OPMs 164 (shown as 164-1 through 164-12), and a support housing structure 168c that takes a form of a baseball cap that contains the OPMs 164 and passive shield 166. The material for baseball cap 168c may be selected out of any suitable cloth, soft polymer, plastic, hard shell, and/or any other suitable material as may serve a particular implementation. The control/processing unit 170c is self-contained, and may take the form of a garment (e.g., scarf) for being worn around the neck of the subject 12. The self-contained control/processing unit 170c may additionally include a power supply (which if head-worn, may take the form of a rechargeable or non-chargeable battery), a control panel with input/output functions, a display, and memory. Alternatively, power may be provided to the self-contained control/processing unit 170c wirelessly (e.g., by induction).

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

1. An authentication system, comprising:
a brain-computer interface (BCI) configured for detecting neural activity in a brain of a subject in response to the subject performing a repeatable mental task, and outputting neural data representative of the detected neural activity;
a computer configured for acquiring the neural data output by the BCI while the subject is performing the repeatable mental task; and
an authentication processor configured for acquiring the neural data from the computer, authenticating the subject based on the acquired neural data, and sending an authorization token to the computer.

2. The authentication system of claim 1, wherein the computer is configured for generating an authorization request containing the neural data, and the authentication processor is configured for acquiring the authorization request containing the neural data from the computer, and authenticating the subject based on the acquired authorization request.

3. The authentication system of claim 1, further comprising a keystore containing one or more keys, wherein the computer is configured for using the authentication token to unlock the keystore, retrieve the one or more keys from the keystore, and access one or more resources using the one or more retrieved keys.

4. The authentication system of claim 1, wherein the neural data output by the BCI is raw neural data, the computer is configured for creating one or more non-fungible tokens (NFTs) from the raw neural data output by the BCI, and the neural data acquired from the computer by the authentication processor comprises the NFTs.

5. The authentication system of claim 1, wherein the computer is configured for prompting the subject to perform the repeatable mental task.

6. The authentication system of claim 5, wherein prompting the subject to perform the repeatable mental task comprises one or more of requesting the subject to think of something, requesting the subject to solve a difficult math problem, telling a joke to the subject, and requesting the subject to laugh.

7. The authentication system of claim 1, wherein the neural data output by the BCI is encrypted.

8. The authentication system of claim 1, wherein the neural data output by the BCI comprises a plurality of neural data samples.

9. The authentication system of claim 1, further comprising a database that stores a neural activity signature of the subject, wherein the authentication processor is configured for retrieving the neural activity signature of the subject from the database, comparing the neural data acquired by the computer to the retrieved neural activity signature of the subject, and authenticating the subject based on the comparison.

10. The authentication system of claim 9, wherein the neural activity signature comprises at least one vector of known identification features, and wherein the authentication processor is configured for extracting a vector of features from the neural data acquired by the computer, comparing the neural data acquired by the computer to the retrieved neural activity signature of the subject by comparing the extracted vector of features to the at least one vector of known identification features, and authenticating the subject if the extracted vector of features matches the at least one vector of known identification features.

11. The authentication system of claim 1, further comprising a secure enclave comprising the authentication processor.

12. The authentication system of claim 1, wherein the authentication processor comprises a neural network.

13. The authentication system of claim 1, wherein the BCI comprises an optical measurement assembly.

14. The authentication system of claim 1, wherein the BCI comprises a magnetic measurement assembly.

15. The authentication system of claim 1, wherein the BCI comprises at least one detector configured for detecting energy from the brain of the user, and processing circuitry configured for identifying the neural activity in response to detecting the energy from the brain of the user.

16. The authentication system of claim 15, wherein the BCI comprises a head-worn unit carrying the at least one energy source.

17. The authentication system of claim 15, wherein the BCI comprises an auxiliary non-head-worn unit carrying the processing circuitry.

18. A method of authenticating a subject, comprising:
performing a repeatable mental task in the subject;
detecting brain activity of the subject in response to the subject performing the repeatable mental task;
outputting neural data representative of the detected neural activity; and
authenticating the subject based on the outputted neural data.

19. The method of claim 18, further comprising:
generating an authorization request containing the neural data, wherein the subject is authenticated in response to the authorization request; and
generating an authorization token in response to authenticating the subject.

20. The method of claim 19, further comprising:
using the authentication token to unlock a keystore;
retrieving one or more keys from the keystore; and
accessing one or more resources using the one or more retrieved keys.

21. The method of claim 18, wherein the outputted neural data is raw neural data, the method further comprising creating one or more non-fungible tokens (NFTs) from the outputted raw neural data, and wherein the subject is authenticated based on the one or more NFTs.

22. The method of claim 18, further comprising prompting the subject to perform the repeatable mental task.

23. The method of claim 22, wherein prompting the subject to perform the repeatable mental task comprises one or more of requesting the subject to think of something, requesting the subject to solve a difficult math problem, telling a joke to the subject, and requesting the subject to laugh.

24. The method of claim 18, further comprising encrypting the neural data.

25. The method of claim 18, wherein the outputted neural data comprises a plurality of neural data samples.

26. The method of claim 18, further comprising:
storing a neural activity signature of the subject;
retrieving the neural activity signature of the subject; and
comparing the outputted neural data to the retrieved neural activity signature of the subject, wherein the subject is authenticated based on the comparison.

27. The method of claim 26, wherein the neural activity signature comprises at least one vector of known identification features, the method further comprising extracting a vector of features from the outputted neural data, wherein comparing the outputted neural data to the retrieved neural activity signature of the subject comprises comparing the extracted vector of features to the at least one vector of known identification features, and authenticating the subject if the extracted vector of features matches the one vector of known identification features.

28. The method of claim 18, wherein the brain activity is optically detected.

29. The method of claim 18, wherein the brain activity is magnetically detected.

30. The method of claim 18, wherein detecting the brain activity of the user comprises detecting energy from a brain of the user, and identifying the brain activity in response to detecting the energy from the brain of the user.

31-44. (canceled)
